(19) United States
(12) Patent Application Publication
(10) Pub. No.: US 2005/0074144 A1
(43) Pub. Date: Apr. 7, 2005

(54) Image processing method and contactless image input apparatus utilizing the method

(76) Inventors: Yuichi Abe, Hitachi (JP); Keisuke Nakashima, Hitachi (JP); Takanari Tanabata, Ishioka (JP); Shinichi Shinoda, Hitachi (JP); Yoshiharu Konishi, Owariasahi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/996,441

(22) Filed: Nov. 26, 2004

Related U.S. Application Data
(63) Continuation of application No. 09/796,614, filed on Mar. 2, 2001.

(30) Foreign Application Priority Data
Nov. 24, 2000 (JP) 2000-362681

(51) Int. Cl. G06K 1/00

(52) U.S. Cl. 382/106; 382/199

(57) ABSTRACT

An image processing method, a contactless image processing apparatus, and a storage medium which stores processes. The method includes the steps of reading an original by a graphics input unit in a contactless manner and outputting from the graphics input unit information as to the original, measuring a distance from the graphics input unit to the original at least on the basis of information as to vertexes which is derived from the information as to the original which has been read and outputted from the graphics input unit and correcting for the information as to the original outputted from the graphics input unit on the basis of the distance which is measured and the information as to the vertexes.

### CROSS REFERENCE TO RELATED APPLICATION

This is a continuation of U.S. application Ser. No. 09/796,614, filed Mar. 2, 2001, the subject matter of which is incorporated by reference herein.

### BACKGROUND OF THE INVENTION

The invention relates to an image processing method of reading image information of a character, a figure, an image, a print of a seal, or the like in a contactless manner and image processing and to a contactless image input apparatus utilizing such a method.

As an image input apparatus, there are a flat bed scanner, a sheet scanner, a digital camera, a calligraphy/paintings camera, and the like. However, according to the flat bed scanner, although a resolution is high, a setting area is large and a reading speed is low. According to the sheet scanner, although a setting area is small, only an image in a sheet shape can be read. According to the digital camera, although a solid object can be photographed, an image such as a document or the like of a high resolution cannot be photographed. According to the calligraphy/paintings camera, although a resolution is high and a solid object can be read, a scale of the apparatus is large and its costs are high. As mentioned above, those image input apparatuses have merits and demerits and cannot satisfy the needs of the user.

As inventions for reading a document in a contactless manner, for example, there have been proposed the methods disclosed in JP-A-8-9102 (prior art 1), JP-A-8-274955 (prior art 2), JP-A-8-154153 (prior art 3: mirror), JP-A-8-97975 (prior art 4: book copy), JP-A-10-13622 (prior art 5: white board), and JP-A-9-275472 (prior art 6: active illumination). The method disclosed in JP-A-11-183145 (prior art 7) has been proposed with respect to measurement of a distance.

As methods introduced in the literatures, there are Matsuyama et al., “Edge Detection and Distance Measurement Using Multifocus Image”, the papers of the Institute of Electronic Information and Communication Engineers of Japan, Vol. J77-D-II, pp. 1048 to 1058, 1994 (literature 1), Kodama et al., “Emphatical Obtaining of Full-Focus Image Using Formation of Arbitrary Focal Image Including Parallax from Plural Images of Different Focal Points and Using Formation of Out-of-focus Image”, Singakuron, Vol., J79-D-II, No. 6, pp. 1046-1053, June, 1996 (literature 2), Seong Ik CHO, etc., “Shape Recovery of Book Surface Using Two Shade Images Under Perspective Condition”, T.IEE JAPAN, Vol. 117-C, No. 10, pp. 1384-1390, 1997 (literature 3), and the like.

According to the above prior arts, a case of reading a document on a plane from an almost upper position is considered as a prerequisite, and the document cannot be read from a free position. Although the method of reading a calibration marker and correcting a measuring position has been also proposed, there is a problem such that the operation is complicated. As methods of measuring the distance from a sensor to a reading surface, there have been proposed a method whereby an observation object is seen from the lateral direction, a method whereby an active illumination is used, a method whereby a stereoscopic camera is used, and the like. However, there are problems such that precision is low and costs are too high.

With respect to the distance measurement, a method whereby a marker whose shape and positional relation have already been known is provided on a target and a distance is measured on the basis of how the target is seen from a camera has also been proposed. However, since such a marker is not provided on an ordinary document, such a method cannot be used for inputting a contactless image. Although a method of reconstructing a front image on the basis of distance data has been also proposed, it is necessary to improve a processing speed in order to allow such an apparatus to be put into practical use as an actual article by a simulation using a computer.

### SUMMARY OF THE INVENTION

It is an object of the invention to provide an apparatus which can input an image of a high picture quality without pressing a folded slip, a thick book, or the like and using any special distance detecting sensor and can remarkably improve an operability of the apparatus.

To solve the above problems, according to the invention, there is provided a method comprising the steps of: reading an original by input means in a contactless manner; inputting-original information; measuring a distance from the input means to the original on the basis of predetermined shape information of the original; and correcting the read original information on the basis of information of the measured distance and vertex information.

There is also provided a storage medium which stores processes comprising the steps of: inputting original information of an original read by input means in a contactless manner; measuring a distance from the input means to the original on the basis of the inputted original information and predetermined shape information of the original; correcting the read original information on the basis of information of the measured distance and vertex information; and outputting a correction result.

There is also provided an apparatus comprising: input means for reading an original put on a copyboard in a contactless manner; distance measuring means for measuring a distance from the input means to the original on the basis of original information read by the input means and predetermined shape information of the original; and correcting means for correcting image information of the read original on the basis of information of the distance measured by the distance measuring means and vertex information.

### BRIEF DESCRIPTION OF THE DRAWINGS

FIG. 1 is a diagram showing an embodiment of a functional block of an image processing method according to the invention;

FIG. 2 is a diagram showing a concept of outline extracting means of the invention;

FIGS. 3A to 3C are diagrams for explaining a concept of vertex extracting means of the invention;

FIG. 4 is a diagram for explaining the concept of the vertex extracting means of the invention;

FIG. 5 is a diagram showing a concept of a patch division of the invention;

FIG. 6 is a diagram showing a concept of vertex z coordinate deciding means of the invention;

FIG. 7 is a diagram showing an iterative convergence calculating flow of the vertex z coordinate deciding means of the invention;

FIG. 8 is a diagram for explaining a formation of a development of a 3-dimensional correction of the invention;

FIG. 9 is a diagram showing a perspective conversion principle of the invention;

FIG. 10 is a diagram showing a concept of a coordinate conversion of the invention;

FIG. 11 is a diagram for explaining a concept of a pixel generation of the invention; and

FIG. 12 is a diagram showing another embodiment of a functional block of an image processing method according to the invention.

### DESCRIPTION OF THE EMBODIMENTS

An embodiment of the invention will be described hereinbelow with reference to the drawings.

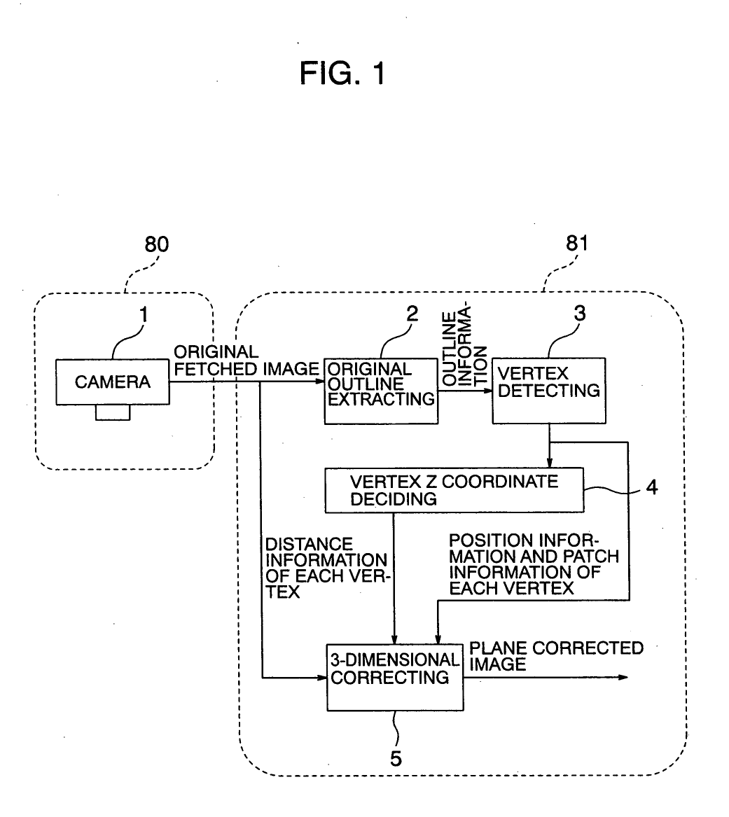

FIG. 1 shows an embodiment of a functional block of a contactless image input apparatus 80 according to the embodiment of the invention. According to the contactless image input apparatus 80 of the invention, an original whose outline has a predetermined shape such as A4-size or the like and which has been put on a desk or the like is read by a camera 1 as input means in a state where it is folded, and read original information is image processed by an image processing unit 81.

The image processing unit 81 extracts the outline of the folded original in the fetched image by original outline extracting means 2, thereby forming outline information. Vertex detecting means 3 detects vertexes in the original in consideration of the outline information and forms position information of each vertex and patch information showing a connection relation thereof. Vertex z coordinate deciding means 4 as distance measuring means measures or calculates distance information of each vertex from the position information of each vertex and the patch information. On the basis of the position information of each vertex, the patch information, the distance information of each vertex, and the original fetched image, 3-dimensional correcting means 5 develops the portion of the folded original in the fetched image into an image at the time when the original is read in a flat state where the folded original correctly faces the camera, and outputs an image which was plane corrected so that the outline is set to a known shape.

By setting an initial value of the vertex z coordinate deciding means 4 by an input from an external distance sensor or the like, calculating time of a z coordinate of the vertex can be reduced and measuring precision of a distance from the external sensor can be improved.

By storing a processing program of the image processing unit 81 of at least the vertex z coordinate deciding means 4 and correcting means 5 into memory means such as a memory (ROM, RAM, etc.) or the like, when the contactless image input apparatus such as digital camera, contactless scanner, or the like is used, by installing the storage medium into a PC or the like, the image data of the folded original which was read can be corrected to a plane image.

The processing program is executed in the contactless image input apparatus and its result can be outputted to the outside.

The contactless scanner of the contactless image input apparatus also incorporates a device which has at least a head portion provided with the camera 1 as input means and has a copyboard on which the original to be read by the camera is put and a supporting portion for connecting the camera and the copyboard.

By providing the vertex z coordinate deciding means and 3-dimensional correcting means as mentioned above, even if a physical distance measuring apparatus is not used, the original image can be outputted from a free position in a form such that the folded original has been corrected to a plane. By providing the original outline extracting means 2 and outline vertex detecting means, the vertexes can be efficiently arranged onto the outline to which the folding state of the original is preferably reflected. The number of vertexes for calculating the z coordinate by the vertex z coordinate deciding means is reduced. The pixel of the plane corrected image can be formed by an interpolating process every patch constructed between the vertexes. Thus, the processing time can be reduced.

It is noted here that the outline may have various shapes such as for example, “a rectangular shape” or the like designated merely using an abstract term, “the ratio of lateral length to longitudinal length being 1:√2” designated using an aspect ratio, “A4 or B5” designated by sheet size, etc.

Information concerning such a shape may be previously set in the apparatus if the contactless image input apparatus is dedicated to fixed-form originals. If the contactless image input apparatus allows inputs of a variety of shapes of originals, the shape information may be inputted by a user according to the shape to be inputted.

For example, where the contactless image input apparatus is constituted by a digital camera, a personal computer and a monitor, the shape information can be inputted by clicking a selection button or entering numerical values directly on a window displayed on the monitor.

Further, the shape information can be inputted using character/symbol information embedded in an original. For example, if a slip whose shape is determined by the slip number thereof is inputted, the shape information can be inputted by identifying the slip number printed on the slip as the original.

In a case where the image input apparatus allows inputs of a variety of shapes of originals, if information as to how an original is deformed is previously known by a user, the information as to deformation of the original may be inputted by the user according to the shape of the original, for simplicity of measurement or adjustment of distance information.

Where the contactless image input apparatus is constituted by a digital camera, a personal computer and a monitor, the information as to deformation of the original can be inputted by clicking a selection button or entering numerical values directly on a window displayed on the monitor. Deformation candidates as selection menu buttons may be a longitudinal-fold, a lateral-fold, a four-fold, etc. of an original. After the image of the original is displayed on the monitor, the information as to deformation of the original may be inputted by clicking a vertex of the image being displayed.

A plurality of solutions may exist according to measurement or adjustment of the distance information. In such a case, a plurality of solutions may be displayed on a monitor so that a user can select the most preferable one. The solutions may be displayed in the form of a wire-frame of a 3-dimensional model for the distance information, an image after adjustment for display of a result of the adjustment, etc.

Further, it is also possible to display 3-dimensional modeling of an object such as an original as it is without adjusting the distance information.

The invention can also provide a similar effect with respect to not only a monochromatic original but also a color original.

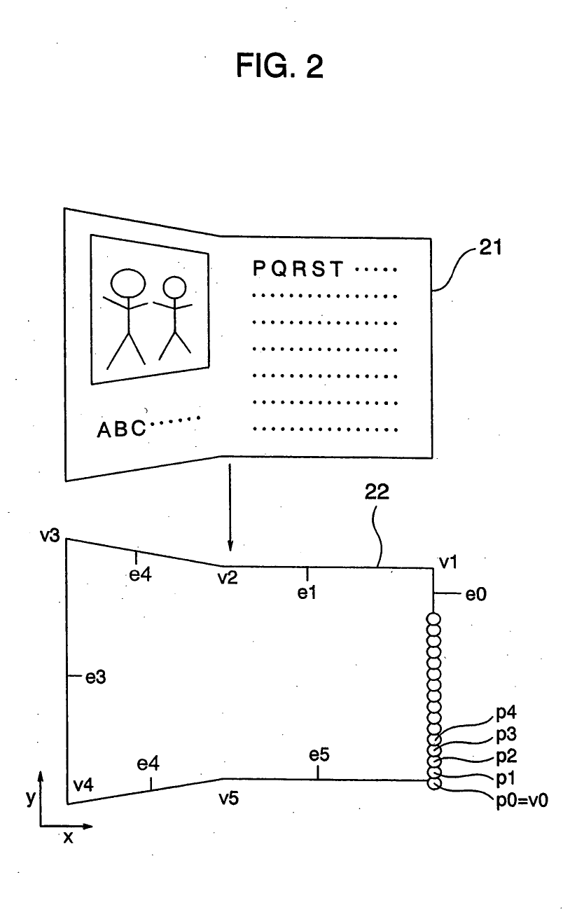

FIG. 2 shows the operation of the original outline extracting means 2. The original outline extracting means 2 obtains outline information 22 by extracting an outline of an original portion 21 in the read image. The outline is a series consisting of a series of coupled pixels existing at a boundary of the inside and outside of the original portion 21 in the read image. The pixels included in the series are coupled with the other outline pixels only in two azimuths. To obtain the outline pixels, it is sufficient to use an outline tracking method which is generally used in the image processes or the like. As outline information, it is possible to use an outline image having a pixel value by which the pixels on the outline can be distinguished from the other pixels, a list of the outline pixels, or any information so long as the outline shape can be reconstructed at necessary precision. In the diagram, p0 to p4 denote numbers allocated to the series of outline pixels in order, v0 to v5 indicate points where the outline is largely folded, that is, vertexes, and e0 to e5 indicate sides obtained by dividing the outline by the vertexes. As the number of vertexes is small, an amount of subsequent calculations decreases. However, it is desirable that the vertexes are representative points showing a feature of the outline. To keep precision, it is preferable to position the vertexes to an extent such that each side can be regarded as a straight line.

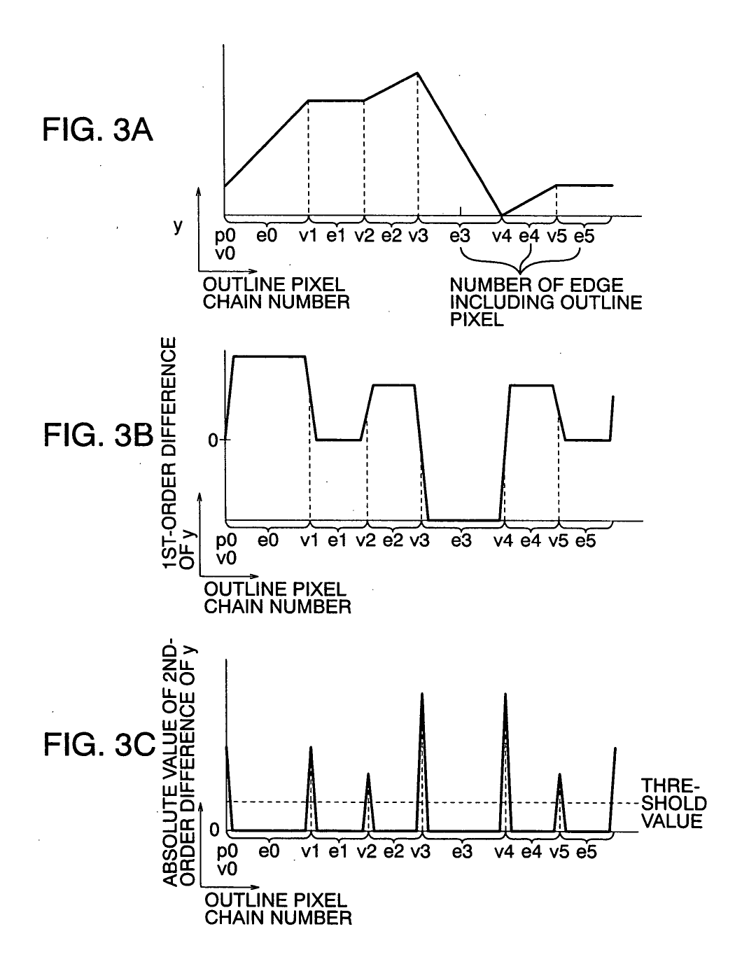

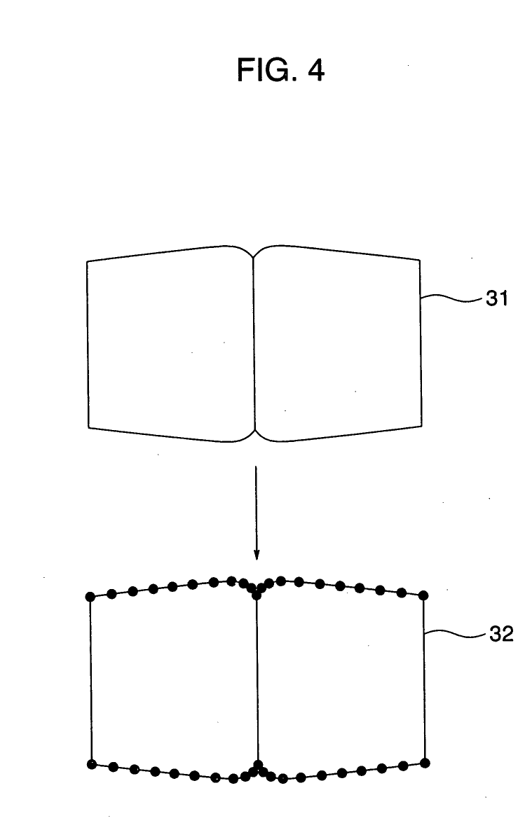

FIGS. 3A, 3B, and 3C show examples of the operation of the vertex detecting means. FIG. 3A is a graph in which with respect to the outline information 22 in FIG. 2, the numbers of the series of the outline pixels are plotted onto an axis of abscissa, and y coordinates of the outline pixels corresponding to the numbers on the axis of abscissa are plotted onto an axis of ordinate. An inclination largely changes at the vertex and an inclination is almost constant on the side. FIG. 3B is a graph in which a first-order difference of the graph of FIG. 3A is shown on an axis of ordinate. An inclination is large at the vertex and an inclination is almost equal to 0 on the side. FIG. 3C is a graph in which a difference (that is, a second-order difference) of the graph of FIG. 3B is further obtained and its absolute value is plotted on an axis of ordinate. Although a positive value is obtained at the vertex, the absolute value is almost equal to 0 on the side. This is also similarly applied to x coordinate. At the vertex, with respect to the x coordinate or y coordinate, an absolute value of the second-order difference thereof is larger than those at the points other than the vertex.

When the vertexes are detected from the outline information, therefore, it is sufficient that a point in which the sum of the absolute values of the second-order differences of the x and y coordinates is larger than a certain threshold value is set to the vertex. As a value to be compared with the threshold value, in place of the sum of the absolute values of the second-order differences of the x and y coordinates, the square root of the square sum or the maximum value can be also used. Although it is the square root of the square sum that enables the vertex to be uniformly detected irrespective of the inclination of the side, a calculation amount is large. It is not always necessary that the difference is a difference between the pixels whose numbers are neighboring but it is sufficient to use differences at regular intervals. If this interval is narrow, an error in the outline extraction is sensitively collected and even a point which is not inherently suitable as a vertex is recognized as a vertex. On the contrary, if the interval is too wide, the sum exceeds the threshold value in a wide range near the vertex and it is difficult to specify the vertex position. If the interval of the differences is set to 2 or more, a process for setting the center point to the vertex instead of all points exceeding the threshold value or the like is necessary.

FIG. 4 shows a process for detecting the vertexes from the outline of the original in the image read by opening a thick book. In case of an original portion 31 or the like of the fetched image of the thick book, since its outline is formed by a curve, if only the points on the outline which is largely folded as shown in the example of FIG. 2 are set to the vertexes, the sides are not regarded as straight lines, and approximate precision of the outline remarkably deteriorates. In such a case, therefore, it is necessary to put the vertexes in accordance with a folding state of the outline. It is desirable to insert the vertexes at shorter intervals into the portion whose curvature is larger as shown by outline information 32 of the thick book. Such a process needs a process for inserting the vertexes when an accumulated value along the outline pixel exceeds a predetermined value in place of the process such that the absolute values of the second-order differences are formed and only the points whose absolute values exceed the threshold value are set to the vertexes as shown in the graph of FIG. 3C. The inserting positions are not limited to those on the outline but the vertexes can be also properly inserted to the original portion of the fetched image. The vertex is a point to obtain the z coordinate by the vertex z coordinate deciding means at the post stage and is a point which becomes a vertex of a polygonal patch division in case of plane correcting the image by the 3-dimensional correcting means. Therefore, it is desirable that the vertexes include a characteristic point such as a point where the outline is folded or the like. However, the points included in the original portion of the fetched image other than those points can be also added. When speaking extremely, although all pixels in the original portion can be set to vertexes, if the number of vertexes increases, processing time is also extended in accordance with it.

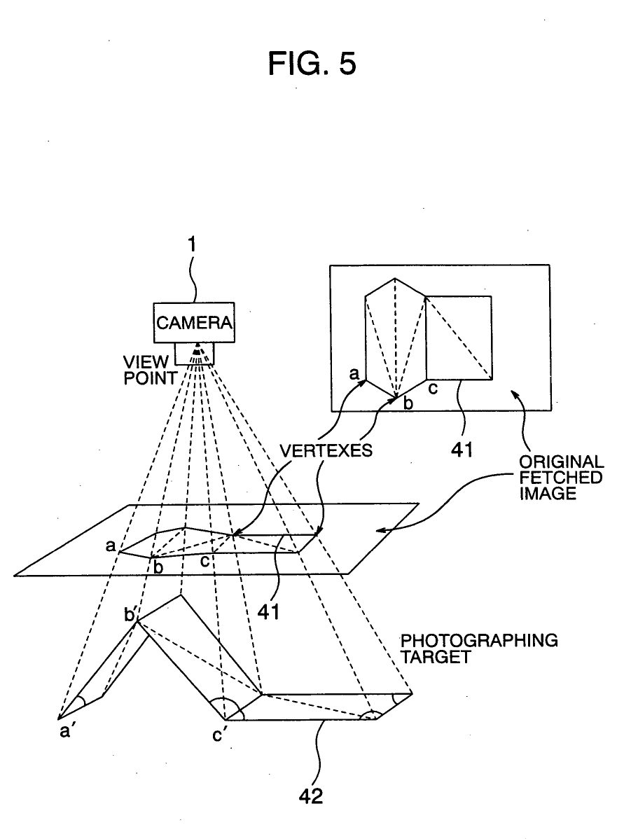

FIG. 5 shows a triangle patch division of the original portion of the fetched image. Each point of an original portion 41 of a fetched image of the original obtained by photographing a photographing target 42 by the camera 1 corresponds to points of the photographing target by a straight line connecting a view point position of the camera 1 and such a point in a one-to-one corresponding manner. From this corresponding relation, the point on the photographing target 42 corresponding to each vertex of the original portion 41 of the original fetched image is also called a vertex on the photographing target. The vertexes of each triangle obtained by dividing the original portion 41 of the original fetched image into the triangle patches is a vertex detected by the vertex detecting means. The side of each triangle is a straight line formed by coupling the vertexes. It is assumed that the following three conditions are satisfied as conditions for the triangle patch division.

1. Each point of the original portion 41 of the read original image has to belong to only one triangle except for the points on the side of the triangle.

2. The vertex must not exist on the side of the triangle.

3. The triangle patch of the original portion 41 of the read original image has to be the triangle patch of the photographing target 42 in the one-to-one corresponding relation. That is, a triangle whose vertexes are equal to three points obtained by projecting three vertexes of each triangle constructing the triangle patch of the original portion 41 of the read original image onto the photographing target 42 in the one-to-one corresponding relation has to closely approximate to the photographing target 42.

For example, although a triangle formed by vertexes a, b, and c of the original read image 41 corresponds to a triangle formed by a′, b′, and c′ of the photographing target 42, since such a triangle does not approximate to the photographing target 42, the triangle formed by vertexes a, b, and c of the original read image 41 cannot become the triangle constructing the triangle patch. If how the triangle is folded is not preliminarily known and the triangle patch cannot be constructed, all straight lines included in the original portion among the straight lines connecting the vertexes are drawn and their cross points are newly added to the vertexes, so that a triangle patch which satisfies the above two conditions can be constructed. However, as a folding state of a paper which occurs in the actual scene, there are predetermined patterns to a certain extent. If the user inputs a predetermined folding pattern mode, the triangle patch division is easily performed. It is also possible to allow the relation between the outline shape or vertex positions of the original portion of the fetched image and the correct patch division to be learned by neurology or the like and efficiently perform the patch division.

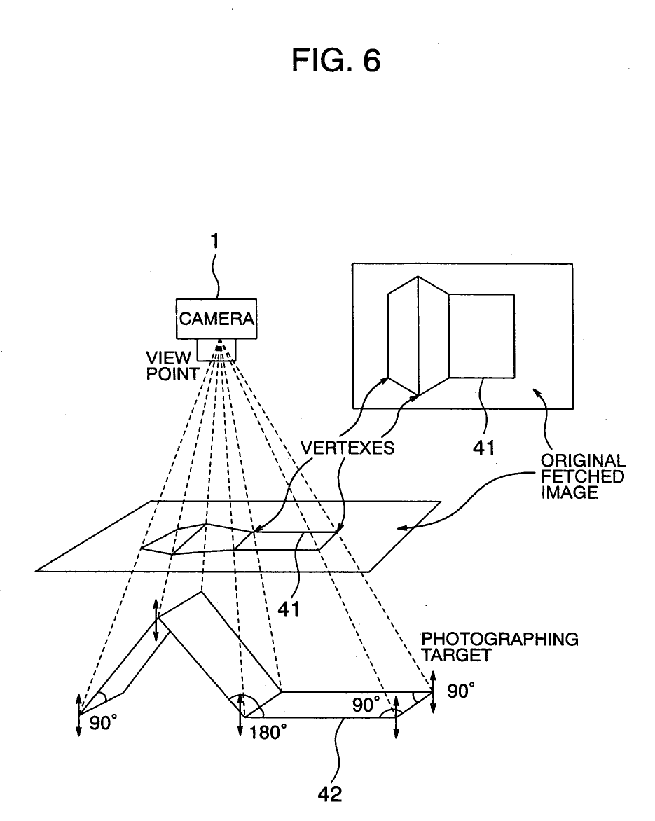

FIG. 6 shows a concept of the operation of the vertex z coordinate deciding means 4. Vertexes on the photographing target 42 are located at any place on a straight line connecting the corresponding vertex of the original read image 41 and the view point position of the camera 1. With respect to each vertex on the photographing target 42, an angle which is formed by the target outline around the vertex when the photographing target 42 is converted into a plane target has been predetermined. For example, in the case where the outline of the original is a rectangle, if the vertexes are located at angles of four corners, an angle around the vertex is equal to 90°. If the vertexes are located on the side of a rectangle, an angle around the vertex is equal to 180°. In the case where the vertex is located on the side of the rectangle, an angle around the vertex is equal to 180°. In the case where the vertex is located in the rectangle, an angle around the vertex is equal to 360°.

Therefore, to presume a shape of the photographing target 42, with respect to each vertex on the photographing target 42, it is sufficient that a position of the vertex such that the sum of the angles of the triangle patches which share such a vertex coincides with an angle formed around the vertex at the time when the photographing target 42 is converted into a plane is found on the straight line. Such a condition can be expressed by simultaneous equations in which a z coordinate of each vertex is used as a variable. The z coordinate of each vertex can be obtained by solving the simultaneous equations. However, since the number of equations is larger than the number of variables and coefficients of the equations also include errors, a solution cannot be obtained actually. Therefore, a solution which optimally satisfies each equation is searched by a method of least squares or the like. Further, if a length of each side of an outline of the photographing target 42 or a ratio thereof is known, it is sufficient to form equations by adding such a condition.

However, a transcendental function such as arccosine or the like is included in such equations and it takes very long time to obtain a solution. Therefore, an easier calculating method will now be described hereinbelow.

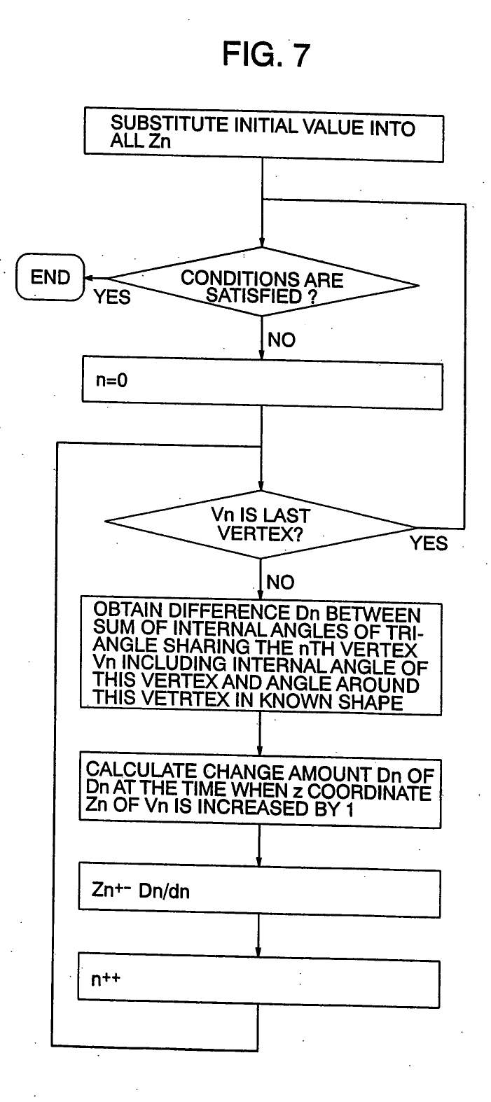

FIG. 7 is a flowchart for a calculating method for obtaining the z coordinate of each vertex of the photographing target 42 by an iterative convergence calculation. In the diagram, n denotes a serial number allocated to the vertex, Vn indicates each vertex, Zn shows a z coordinate of each vertex, Dn a difference between the sum of internal angles including Vn of all of the triangle patches of the photographing target 42 which shares Vn and the angle around Vn in a known shape at the time when the photographing target 42 is converted into a plane, and dn indicates a change amount of Dn at the time when Zn is increased by “1”. An algorithm in this instance is as follows.

A proper initial value, for example, 1 has initially been allocated to all Zn.

Dn/dn is added to each Zn, that is, Zn is changed so as to minimize Dn in the primary prediction.

The above processes are executed at all vertexes.

The above series of processes are repetitively executed until end conditions are satisfied.

With respect to the initial value of Zn, if information from the outside obtained by a distance sensor or the like is set to the initial value of Zn, a convergence is executed early and distance information of precision higher than that of the information obtained by a sole sensor is derived.

There are end conditions such as “the series of processes were repeated the predetermined number of times”, “a change amount of Zn lies within a predetermined range”, and the like. Since the primary prediction is used here, when dn is small, a fluctuation of Dn/dn increases, and there is a tendency such that the prediction is largely deviated. Therefore, it is also effective to clamp Dn/dn to a predetermined value, that is, replace it with a predetermined value when it exceeds a certain value. Further, according to the above algorithm, when the process is executed every vertex, attention is paid only to the angle around the vertex. However, it is more preferable to consider all angles which are influenced by the movement of the z coordinate of the vertex. An evaluating function of the primary prediction can also include not only the angles but also the lengths of sides or the ratio thereof.

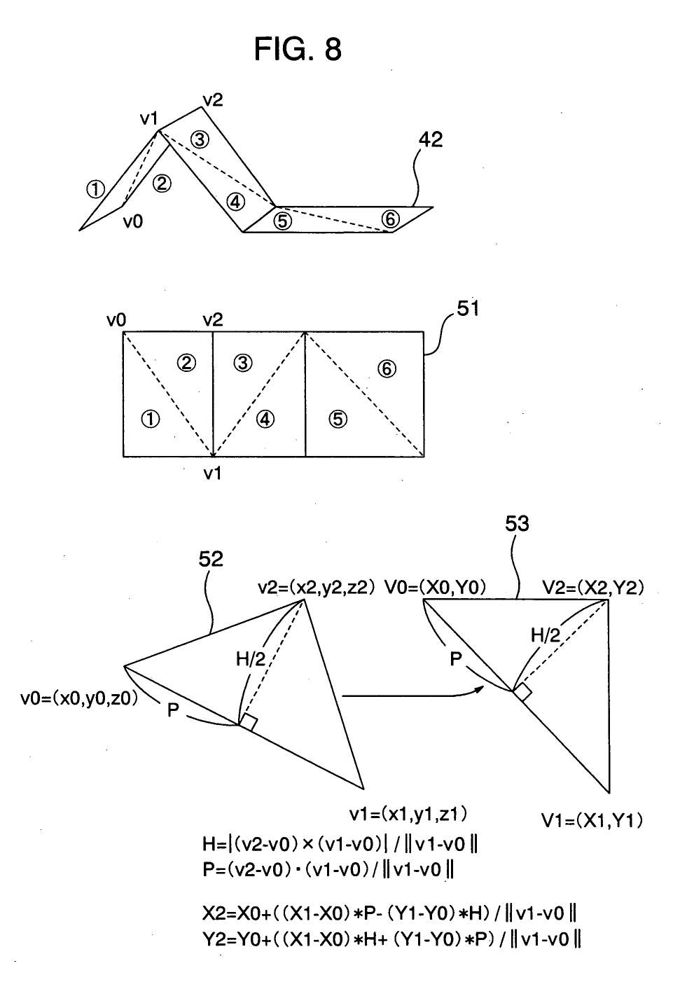

FIGS. 8 to 11 show the operation of the 3-dimensional correcting means.

FIG. 8 shows a method of developing the photographing target into a plane. The photographing target 42 is constructed by triangle patches (1) to (6). v0 to v2 denote three vertexes of the triangle (2). A development 51 of the photographing target 42 is a diagram obtained by developing each triangle patch into a plane. V0 to V2 denote vertexes corresponding to v0 to v2. When the development is formed, according to rules such as “With respect to the triangle patches other than the triangle patches whose positions have been determined first, their positions are decided in order from the triangle patches which share the sides with the triangle patches whose positions have already been determined.” and “The triangle patches which share the sides are arranged without forming a gap.”, the triangle patches other than the triangle patches whose positions have been determined first belong to one of the following two cases when their positions are determined.

1. Three vertexes of the triangle patch have already been determined.

2. Two vertexes of the triangle patch have already been determined and it is sufficient to decide the position of the third vertex.

Since the positions of all three vertexes have already been determined in the first case, a method of deciding the position of the third vertex in the second case will now be shown. A triangle 52 is a diagram written by magnifying the triangle patch (2) of the photographing target 42. In the case where the position of (1) has already been determined and the position of (2) is decided from it, since v0 and v1 have been positioned to V0 and V1 of the development 51, a method of deciding the position V2 in the development 51 of v2 will be described.

P denotes a length obtained when the side (v0, v2) of the triangle 52 is orthogonally projected to the side (v0, v1). H indicates a length that is twice as long as a perpendicular dropped from v2 to the side (v0, v1). In a triangle 53 in the development 52, V2 can be determined so as to keep those two lengths. Assuming that coordinates of Vi are equal to (Xi, Yi), H and P can be expressed as follows.
H=|(v2−v0)×(v1−v0)|/||v1−v0||
P=(v2−v0)·(v1−v0)/||v1−v0||

X2 and Y2 can be expressed as follows.
X2=X0+((X1−X0)*P−(Y1−Y0)*H)/||V1−V0||
Y2=Y0+((X1−X0)*H+(Y1−Y0)*P)/||V1−V0||

According to the above calculations, V2 can be obtained even if the lengths of the side (v0, v1) and the side (V0, V1) are different due to the calculation error.

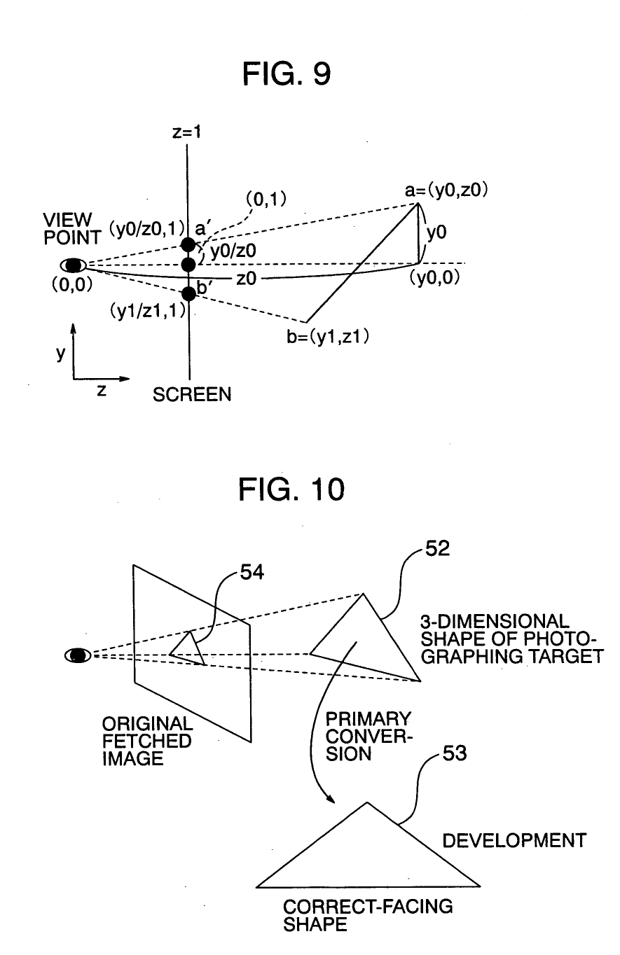

FIG. 9 schematically shows a geometrical relation between the photographing target and the fetched image. A view point indicates a view point of the camera. A straight line ab shows the photographing target. A screen of z=1 shows a photographing surface as a front surface of the camera. y denotes a position coordinate in the vertical direction. z indicates a distance from the view point. A point a corresponds to a′ on the photographing surface and a point b corresponds to b′ on the photographing surface. Assuming that a=(y0, z0), a foot of the perpendicular obtained by dropping a to a z axis is located at (y0, 0).

A triangle formed by those two points and the view point is similar to a triangle formed by a′, the foot of the perpendicular obtained by dropping a′ to the z axis, and the view point. A similarity ratio is equal to z0:1. Therefore, a′ is expressed by (y0/z0, 1). As mentioned above, there is a relation such that the coordinate values are equal to z:1 between the photographing target and the y coordinate (this is also similarly applied to the x coordinate) of the fetched image. Although the plane in case of z=1 is now regarded as a photographing surface for convenience of explanation, this is also similarly applied to the other values.

FIG. 10 shows a geometrical positional relation among the photographing target 52, an original fetched image 54, and the development 53. There is a relation between the photographing target 52 and the original fetched image as mentioned above. The development 53 is a diagram obtained by primarily converting the photographing target 52. Fundamentally, although only the rotation and the parallel movement are performed, since there is a case where an inclination, an enlargement, or a reduction occurs depending on a calculation error, it is better to regard such a conversion as a general primary conversion.

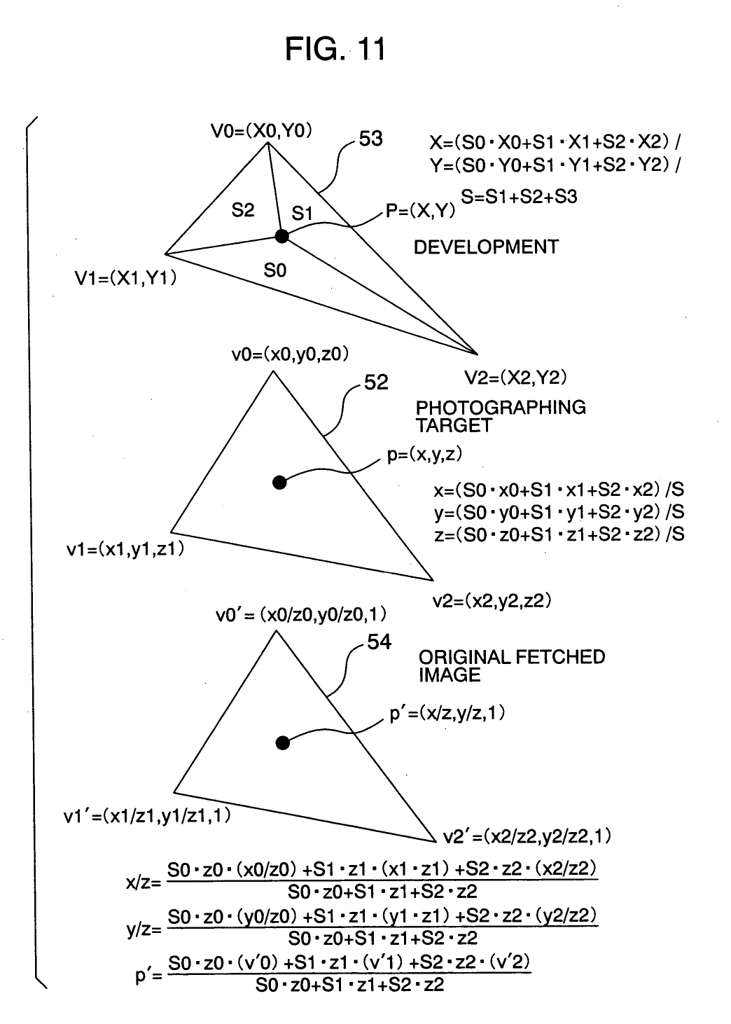

FIG. 11 shows a corresponding relation of the coordinates among the photographing target 52, original fetched image 54, and development 53. When a development is actually formed from a plane corrected image, each pixel value of the development has to be formed from the pixel values of the corresponding pixel of the original fetched image. Each vertex of the triangle of the development 53 is assumed to Vi=(Xi, Yi), each vertex of the photographing target 52 is assumed to vi=(xi, yi, zi), and each vertex of the original fetched image 54 is assumed to vi′=(xi/zi, yi/zi, 1). A case of forming the pixel P=(X, Y) of the development 53 will now be considered. With respect to each Vi, now assuming that an area of the triangle formed by an opposite side of Vi and P is set to Si and a whole area is set to S, the pixel P=(X, Y) can be expressed as a primary coupling of each vertex Vi by the following equations (1) and (2).
X=(S0·XO+S1·X1+S2·X2)/S (1)
Y=(S0·YO+S1·Y1+S2·Y2)/S (2)

Since the conversion from the photographing target 52 to the development 53 is the primary conversion, a corresponding point p=(x, y, z) of the photographing target 52 is also expressed by the primary coupling of the same coefficients as those of the equations (1) and (2) by the following equations (3), (4), and (5).
x=(S0·xO+S1·x1+S2·x2)/S (3)
y=(S0·yO+S1·y1+S2·y2)/S (4)
z=(S0·zO+S1·z1+S2·z2)/S (5)

Further, a corresponding point p′=(x/z, y/z, 1) of the original fetched image 54 is expressed by the following equation (6) from the equations (3) to (5).
p′=(S0·z0·v0′+S1·z1·v1′+S1·z1·v1′)/(S019 zO+S1·z1+S1·z1) (6)
where, Si is determined depending on P and zi is decided by the vertex z coordinate deciding means.

To form the pixel P of the development 53, therefore, it is sufficient to obtain the corresponding point p′ of the original fetched image 54 by the equation (6) and get a pixel value of the pixel closest to the point p′ or a weighted mean or the like of the peripheral pixels of the point p′.

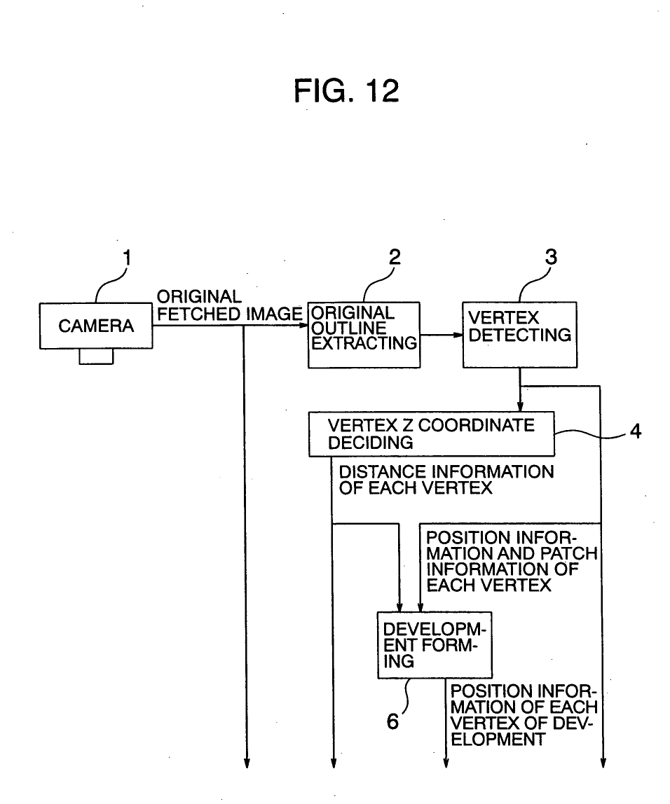

FIG. 12 shows a functional block diagram of a contactless original modeling apparatus according to another embodiment of the invention.

According to the contactless image input apparatus of the invention, the original whose outline is a known shape such as A4 or the like and which is put on a desk or the like is read by the camera 1 in a folding state. The outline of the folded original in the fetched image is extracted by the original outline extracting means 2, and the outline information is formed. The vertex detecting means 3 detects the vertexes in the original in consideration of the outline information, and forms the position information of each vertex and the patch information showing their connecting information. The vertex z coordinate deciding means 4 calculates the distance information of each vertex from the position information of the vertex and the patch information. The development forming means 6 having only the development forming function of the 3-dimensional correcting means 5 forms the position information of each vertex of the development from the position information of each vertex, the patch information, and the distance information of each vertex. A commercially available graphics chip can form a plane corrected image by using the position information, the patch information, the distance information of each vertex, the position information of each vertex of the development, and the information of the original read image.

1. An image processing method comprising the steps of:
reading an original by a graphics input means in a contactless manner and outputting from the graphics input means information as to the original;
measuring a distance from the graphics input means to the original at least on the basis of information as to vertexes which is derived from the information as to the original which has been read and outputted from the graphics input means; and
correcting for the information as to the original outputted from the graphics input means on the basis of the distance which is measured and the information as to the vertexes.

2. A method according to claim 1, wherein the information as to the vertexes is derived on the basis of outline information extracted from the information as to the original which has been read outputted from the graphics input means so that the distance measurement is effected without utilization of a separate distance sensor.

3. A method according to claim 1, wherein
the correction of the information as to the original is a correction to develop the information as to the original which is read into a plane, and
the information as to the vertexes is vertex information of a patch for forming pixels by an interpolation of each patch at the time of the correction.

4. A method according to claim 2, wherein
the correction of the information as to the original is a correction to develop the information as to the original which is read into a plane, and
the information as to the vertexes is vertex information of a patch for forming pixels by an interpolation of each patch at the time of the correction.

5. A method according to claim 1, wherein an iterative convergence calculation is performed when the distance from the graphics input means to the original is measured.

6. A method according to claim 2, wherein an iterative convergence calculation is performed when the distance from the graphics input means to the original is measured.

7. A method according to claim 3, wherein an iterative convergence calculation is performed when the distance from the graphics input means to the original is measured.

8. A method according to claim 4, wherein an iterative convergence calculation is performed when the distance from the graphics input means to the original is measured.

9. A method according to claim 5, wherein an initial value of the iterative convergence calculation is inputted.

10. A method according to claim 6, wherein an initial value of the iterative convergence calculation is inputted.

11. A method according to claim 7, wherein an initial value of the iterative convergence calculation is inputted.

12. A method according to claim 8, wherein an initial value of the iterative convergence calculation is inputted.

13. A storage medium which stores processes, wherein the processes comprise the steps of:
receiving information as to an original which is read by a graphics input means in a contactless manner and outputted therefrom;
measuring a distance from the graphics input means to the original at least on the basis of information as to vertexes which is derived from the information as to the original which has been read and outputted from the graphics input means; and
correcting for the information as to the original outputted from the graphics input means on the basis of the distance which is measured and the information as to the vertexes and outputting a correction result.

14. A contactless image input apparatus comprising:
graphics input means for reading an original put on a copyboard in a contactless manner and outputting information as to the original to a processor;
wherein the processor includes:
distance measuring means for measuring a distance from said graphics input means to said original at least on the basis of information as to vertexes derived from the information as to said original which has been read and outputted from said input means graphics; and
correcting means for correcting said information as to said original on the basis of the distance which is measured by said distance measuring means and the information as to the vertexes.

15. An apparatus according to claim 14, further comprising:
outline extracting means for extracting an outline of said original from said information as to said original outputted from said graphics input means; and
vertex detecting means for detecting the information as to the vertexes on the basis of said outline extracted by said outline extracting means.

16. An apparatus according to claim 14, wherein said correcting means performs a correction for developing said information as to said original into a plane.

17. An apparatus according to claim 14, wherein said distance measuring means measures the distance by performing an iterative convergence calculation.
